(19) United States
(12) Patent Application Publication
(10) Pub. No.: US 2007/0073917 A1
(43) Pub. Date: Mar. 29, 2007

(54) Method for controlling the rate of automated flow and navigation through information presented on a digitally controlled electronic device

(75) Inventors: Craig J. Larson, Jasper, GA (US); Howard R. Davis III, Atlanta, GA (US); Gary R. Steele I, Roswell, GA (US); Victor Coleman, Atlanta, GA (US)

Correspondence Address: DUANE MORRIS LLP, 1667 K. STREET, N.W., SUITE 700, WASHINGTON, DC, 20006-1608, US

(73) Assignee: VUBOTICS, INC., Atlanta, GA (US)

(21) Appl. No.: 11/515,950

(22) Filed: Sep. 6, 2006

Related U.S. Application Data
(60) Provisional application No. 60/714,736, filed on Sep. 7, 2005.

(51) Int. Cl. G06F 3/00

(52) U.S. Cl. 710/14

(57) ABSTRACT

An apparatus and method for controlling the delivery and presentation of information using an information delivery device is disclosed. Additionally disclosed is an apparatus and method for changing a mode of operation and a speed of delivery of information when in an automated sequential information delivery mode by use of a single input mechanism. Furthermore, an apparatus and method for controlling an information delivery device in an automated information delivery mode and a navigation mode is disclosed.

### CROSS-REFERENCE TO RELATED APPLICATIONS

The present application hereby incorporates by reference in its entirety and claims priority benefit from U.S. Provisional Patent Application Ser. No. 60/714,736 filed on 7 Sep. 2005.

### BACKGROUND

The present disclosure relates to controlling the rate of flow of information presented to the user from an information delivery device. Non-limiting examples of an information delivery device include personal data assistants (“PDAs”), personal information managers (“PIMs”) and other devices, preferably portable and/or handheld devices.

With the growing use of handheld electronic display devices, the need for improved visual, audio, and/or audio-visual recognition of presented information has grown. In one embodiment of the disclosure, to facilitate the demand for more discernable text, for example, a method of content presentation sometimes referred to as “sequential delivery” may be employed. When only one word or short groups of words at a time are delivered to a display, and with that one word or short groups of words being replaced with the next in the place of the previous, the total quantity of characters that are displayed may be decreased. This in turn promotes the rendering of these characters to much larger sizes. Enlarging character size obviously improves visibility.

Another factor which effects readability is navigation through a list containing, for example, titles of songs, chapter headings, or other lists of information. For a conventional page of text to be displayed on the typically small screen of a handheld device, there is a constant adjustment to a desired location within the list of information to expose the next grouping of words or images. On handheld digital devices the need for simplicity is even more important in that these small appliances are usually held with only one hand and consequently are most preferable when they are able to be controlled with only one hand.

Control mechanisms sometimes referred to as jog wheels, thumb rollers, click-and-scroll wheels, roller wheels, spin wheels, shuttle wheels, or track wheels are presently used, for example, to move forward and backward within media during edit and play sessions. Additionally, other mechanisms such as joy sticks, multi-function buttons, touch screens, or slides, etc., can also be used. Typically, all of these mechanisms have multistate operability, i.e., there generally is more than one way to actuate the mechanism to effectuate an input. For example, a joy stick may be moved in the vertical direction to change a mode of operation of the device the joy stick is controlling, and the joy stick may be moved in a horizontal direction to change the rate of flow of information when in one or more of the modes of operation. Similarly, click-and-scroll wheels can be “clicked” by depressing the wheel to effectuate one type of operation and can be “rolled” to effectuate another type of operation. Additionally, these mechanisms may be used, for example, to alter a position of a cursor within linear content such as music and video, or scroll left-right and up-down through an alphanumeric document.

An improvement to this type of human interface would further minimize the number of key strokes and actions performed and provide for faster and more accurate positioning. One such improvement was the combination of a rotary wheel with a depression switch, as mentioned above. This combination of electromechanical switches allows for positioning and with the depression of the same wheel a selection can be triggered, This combination is also exemplified on some computer mice. This type of dual function switching-adjustment element may be referred to herein as a scroll wheel. Depressing the wheel as a triggering mechanism may sometimes be referred to herein as an actuator, with the action of depressing the wheel referred to as a “click”.

Typical information delivery devices require multiple mechanisms for controlling the speed at which information flows from a device as well as providing a means of pausing the delivery of information and navigating to a particular location in a list or stream of information. The operation of these multiple mechanisms is cumbersome, confusing and prone to operator error.

### SUMMARY OF THE DISCLOSURE

When employing an automated sequential method of delivery, for example, information such as words, small groups of words, sounds, and/or images may be “flashed”, i.e., the new information may replace old information within the same physical space or delivered via the same mode of delivery (e.g., screen, speaker, etc.). In an embodiment of the present disclosure, a mechanism may have an ability to control the speed at which information flows from a device as well as providing a means of pausing the delivery of information and navigating to a particular location in a list or stream of information. Typically, for example, the navigating function requires greater scrutiny within the body of information and/or sequentially-delivered information. In an embodiment of the present disclosure is disclosed methods and apparatus for combining the above-mentioned functions into a single control mechanism which is may be operable by using one hand or just one thumb or finger.

### BRIEF DESCRIPTION OF THE DRAWINGS

FIG. 1 illustrates an exemplary handheld electronic device on which embodiments of the present disclosure may be implemented.

FIG. 2 is a block diagram illustrating a schematic flow of control functions for automated flow and navigation for an embodiment of the present disclosure.

FIGS. 3A-3C illustrate exemplary screen displays associated with an embodiment of the present disclosure.

### DETAILED DESCRIPTION OF THE DISCLOSURE

The following description of the disclosure is provided as an enabling teaching of the disclosure and its best, currently-known embodiment. Those skilled in the art will recognize that many changes can be made to the embodiments described herein while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations of the disclosure are possible and may even be desirable in certain circumstances and are part of the present disclosure. Thus, the following description is provided as illustrative of the principles of the disclosure and not in limitation thereof. While the following exemplary discussion of embodiments of the present disclosure may be directed towards textual and visual displays, it is to be understood that the discussion is not intended to limit the scope of the disclosure in any way and that the principles presented are equally applicable to other types of information capable of being delivered by an information delivery device, such as visual information, audio information, and audio-visual information to name a few.

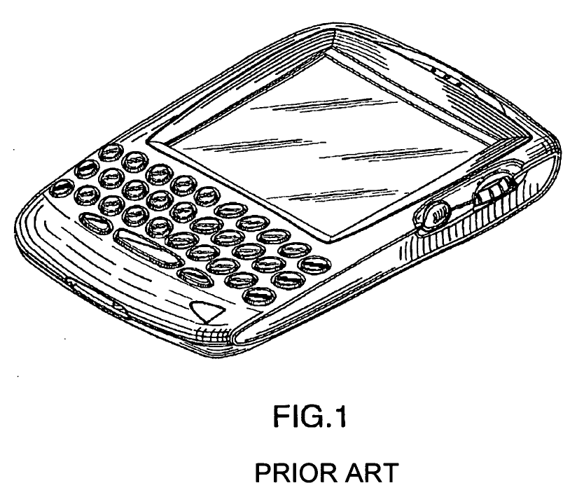

One aspect of the present disclosure may be directed to a method of controlling the automated flow of information and navigating through that information on a small handheld information delivery device such as, for example, a mobile device such as a Blackberry handheld device available from Research In Motion, Limited, and illustrated in FIG. 1. One aspect of the present disclosure uses a scroll wheel on the information delivery device to control the rate of an automated display of text while in automated display mode. Moving the scroll wheel up (e.g., counterclockwise) increases the rate of delivery of information (which may be thought of as delivery of sequential information) while moving the scroll wheel down (e.g., clockwise) decreases the rate of delivery of information. The major subsystem elements and logic circuitry of a typical handheld electronic device are described in various patents, including U.S. Pat. No. 6,919,879 (“'978”), which teaches the use of a thumb-wheel with a push-button single pole, single throw (“SPST”) switch with quadrature signal outputs. The external design of an exemplary handheld information delivery device is shown in U.S. Design Pat. No. D490,119 (“'119”). Both the '978 and the '119 patents are hereby incorporated by reference in their entirety.

In an embodiment of the disclosure, the flow of textual information while in automated display mode may be stopped by clicking the scroll wheel once. This action may pause the information delivery on the current word or image being displayed. Additionally, this action may also convert the functionality of the scroll wheel to a navigation mode in which the user can scroll forward or backwards in a word-by-word or image-by-image manner, for example, at a pre-designated speed. The user may return from the navigation mode to the automated display mode by, for example, clicking the scroll wheel twice. This double-clicking action may start the automated display at the presently-displayed word or image, for example. Additionally, the speed at which the words and/or images are displayed when returning to the automated display mode may be the same as when the user was last in the automated display mode. It is also contemplated that the speed of information delivery when returning to the automated display mode defaults to a preset initial speed. Furthermore, the user may access a program menu with, for example, a single click of the scroll wheel.

An exemplary Java code for the above-described functionality may be as follows:

/* Invoked when the trackwheel is clicked. */
public boolean trackwheelClick( int status, int time ) {

if (wordFlashingThread !=null &&
!wordFlashingThread.isPaused( )) {

wordFlashingThread.togglePause( );

}
else {

if (wordFlashingThread != null) {

wordFlashingThread.pause( );

}
Menu menu = new Menu( );
makeMenu( menu, 0);
menu.show( );

}
invalidate( );
return true;

}
/* Invoked when the trackwheel is rolled. */
public boolean trackwheelRoll(int amount, int status, int time) {

if (wordFlashingThread !=null) {

if (wordFlashingThread.isPaused( )) {

wordFlashingThread.move(amount);

}
else {

int newWpm = wpm + (WPM_INCREMENT *
amount);
if (newWpm >= WPM_MIN && newWpm <=
WPM_MAX) {

wpm = newWpm;
vWordStream.setWordsPerMinute(newWpm);

}

}

}
invalidate( );
return false;

}

The above-described method for using a depressible rotating wheel (click-and-scroll wheel) control mechanism on an information delivery device for controlling the speed of automatic sequential display and navigation through text or images can also be used, for example, for scanning through a list of titles, names, series of pictures, sound clips, or video. According to an embodiment of the disclosure, such a list may be selected through standard means and then displayed sequentially at a rate previously selected by the user. In the same manner described above for the control of the rate of speed of sequentially-displayed text, the scroll wheel can be used to increase or decrease the rate of display of a collection of images.

In one embodiment of the present disclosure, if the user wants to examine the material at a particular location within a stream of information being presented, the user can perform a “single-click” operation of the scroll wheel control mechanism. This action may pause the delivery of information at the currently-presented word, image, etc. The user can then navigate in a slower or more controlled manner by, for example, rotating the scroll wheel control mechanism counterclockwise or clockwise to change the order of delivery of the information being presented (i.e., go “backwards” or “forwards” through the information). In one embodiment, the information being presented may be displayed in a separate partitioned area of the display area (or screen) to enhance the ability of the user to precisely locate the information of interest.

As a non-limiting example, if a user is attempting to locate information regarding a person whose information is in a database that can be displayed on the user's information delivery device, and the user can only remember that person's first name but thinks that he can recognize the person's last name, the user could select for display the last names of those people who have the recalled first name. These names could then be displayed sequentially at a rate of speed selected by the user. If the speed initially selected by the user was either too fast or too slow, the user could, by using the scroll wheel control mechanism, change the rate of speed for displaying the sequential information. If, while watching the sequential display of information, the user thought that he saw the last name that he was trying to recall, the user could click the scroll wheel control mechanism once to pause the display and then, if necessary, rotate the scroll wheel control mechanism to scroll forward or backwards in a slower and/or more controlled manner until he came to the name he thought he recognized. Similarly, the above-described operation may be used by, for instance, a movie sound designer to listen to a large number of similar sound effects and then navigate to the particular sound effect that caught his attention. As would be obvious to those of skill in the art, the same operating principles could be used to view and navigate through groups of images, pictures, video clips, or combinations thereof.

Another exemplary use of the above-described control mechanism, or interface, design is scanning a list of titles by a particular composer or musical group for a particular song. For example, if a user wanted to locate a particular song that he knew was performed by a particular musician, but did not recall the exact title, he could use this method to scan through the list on a handheld music player and then stop the scan when the name appears to as to navigate, as described above, to the location in the list of the song title of interest.

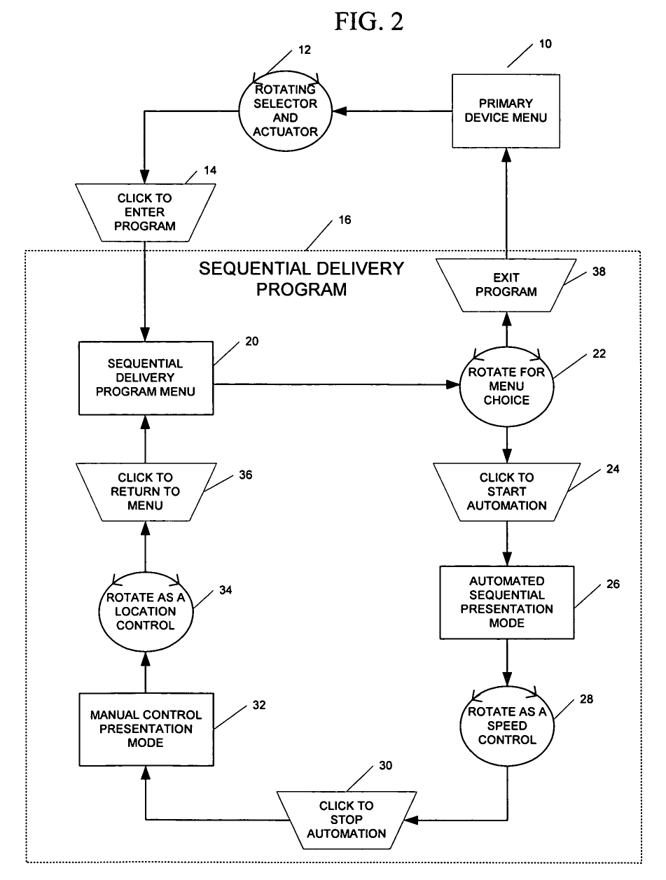

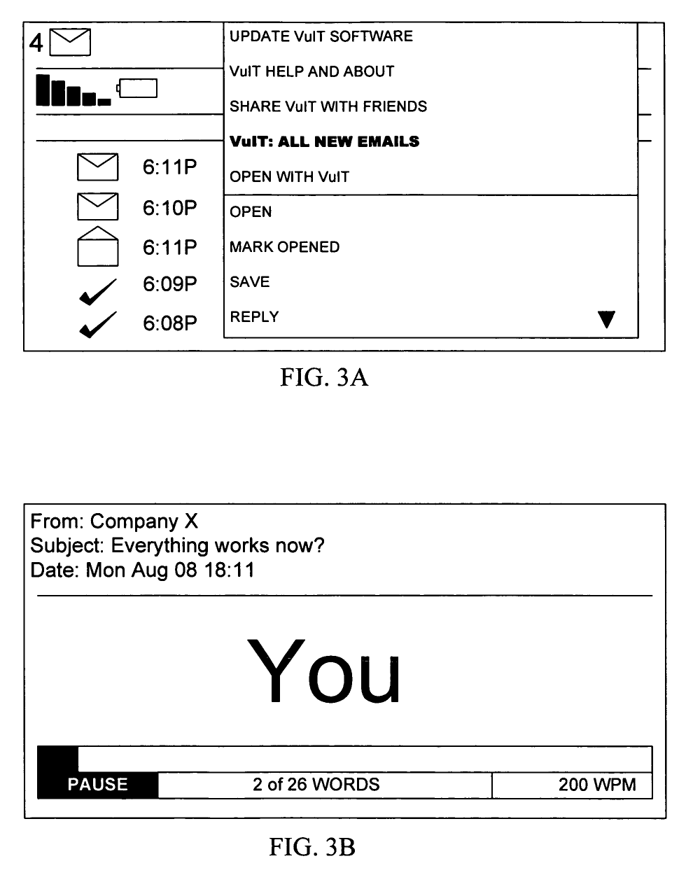

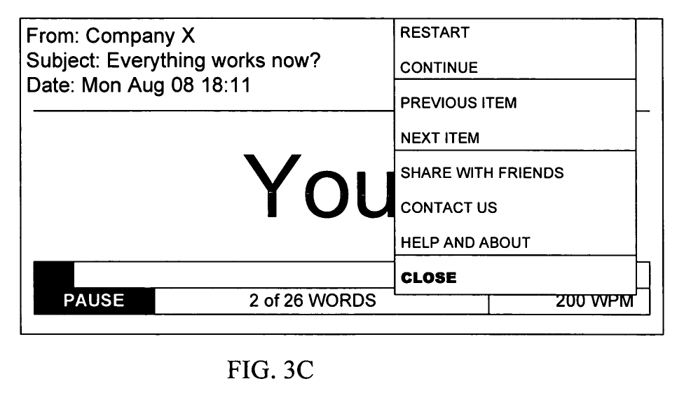

With reference now to FIG. 2, a block diagram illustrating a schematic flow of control functions for automated flow and navigation for an embodiment of the present disclosure is shown. A primary device menu 10 is shown for an information delivery device, which may be a digitally-controlled device. The information delivery device 10 is controlled by a control mechanism which may be a rotating selector and actuator 12 (e.g., a click-and-scroll wheel). The user may enter a software program implementing the method described above by scrolling through the primary device menu 10, which may contain a list of available programs, and selecting the sequential delivery program 16 by clicking 14 the control mechanism. Doing so may present on the screen the sequential delivery program menu 20. FIG. 3A illustrates an exemplary screen display of the sequential delivery program menu referred to in FIG. 3A as “VuIT”. By rotating 22 the rotating selector and actuator 12 the user can, for example, change options, select a file to be presented, or exit the program 38, among other actions. Clicking 24 the rotating and selector actuator 12 while a particular file listed on the sequential delivery program menu 20 is selected changes the mode of operation to automatic sequential presentation mode 26, which begins the automated delivery of information contained in the selected file. The automated delivery of information may occur at an initial preset rate. The information in the file may be text displayed as single words, groups of words, titles, pictures, video clips, audio tracks, etc., or combinations thereof. FIG. 3B illustrates an exemplary display. While in the automated sequential presentation mode, the rate of delivery of the information in the selected file can be changed by rotating 28 the rotating selector and actuator 12, for example rotation in the counterclockwise direction may increase the rate of delivery of the information while rotation in the clockwise direction may decrease the rate of delivery of the information. The automated sequential presentation mode may be stopped by clicking 30 the rotating selector and actuator 12, which switches the mode of operation to the manual control presentation mode 32. FIG. 3C illustrates an exemplary screen display in the manual control presentation mode. While in the manual control presentation mode, the user may rotate 34 the rotating selector and actuator 12 to control the order of delivery of the information, i.e., the user can move backward or forward through the information, which may be at a preset rate. The user may resume the automated sequential presentation mode 26 by double-clicking the rotating selector and actuator 12. The first click 36 returns the program to the Sequential Delivery Program Menu 20 and the second click 24 changes the mode of operation to automatic sequential presentation mode 26, which begins the automated delivery of information contained in the selected file, as described above. Upon resuming the automated sequential presentation mode, in one embodiment the user would be at the point in the file that was last selected prior to leaving the automated sequential presentation mode. The user may also single click 36 to return to the sequential delivery program menu 20 and rotate 22 the rotating selector and actuator 12 to locate another file to be presented, or for changing options, or for exiting the program 38, as described above.

The present disclosure can be applied to a variety of information delivery devices having a control mechanism, e.g., music players such as the Apple iPod, PDAs such as the Palm Treo, etc. Additionally, as would be obvious to those of skill in the art, the present disclosure is applicable to audio, video, and audio-visual information which may be sequentially delivered to a device, such as a handheld device, that has a control mechanism such as, for example, a click-and-scroll wheel or a touch sensitive click wheel as used with the Apple iPod. Furthermore, when audio or video is sequentially presented by an information delivery device that has a click-and-scroll wheel, or similar input mechanism, the scroll wheel can be used not only to quickly scroll through a list of titles that can be selected by clicking the wheel when the desired title is found, but also used to control the volume of the playback by clicking the wheel to pause the sequential delivery. After the volume is changed using the wheel, clicking again will resume the audio or video delivery and presentation to the user.

A method for controlling the rate of automated flow and navigation through information on an electronic device as described herein may be implemented using a computer process and/or by use of a microprocessor. However, as known to those of skill in the art, the use of a computer process and/or a microprocessor is not necessarily required. Those of skill in the art will appreciate that the mechanism and operation thereof described herein is capable of being distributed as a program product in a variety of forms, and that the present disclosure applies regardless of the particular type of information-signal bearing media utilized to carry out the distribution of the information. Non-limiting examples include recordable-type media such as diskettes or CD-ROMs, and transmission-type media such as analog or digital communications links.

The corresponding structures, materials, acts, and equivalents of any and all means-plus-function elements in any claims below are intended to include any structure, material, or acts for performing the function in combination with other claim elements as specifically claimed.

Those skilled in the art will appreciate that many modifications to the exemplary embodiment are possible without departing from the spirit and scope of the present disclosure. In addition, it is possible to use some of the features of the present disclosure without the corresponding use of the other features. Accordingly, the foregoing description of exemplary embodiments is provided for the purpose of illustrating the principles of the present disclosure and not in limitation thereof.

We claim:

1. An apparatus for controlling a device delivering information, comprising:
a device for delivering information;
software configured to present said information in a plurality of modes; and
a single mechanism having multistate operability, wherein a first state switches said device between the plural modes of operation and a second state controls a rate of delivery of said information when in a first of said plural modes of operation.

2. The apparatus of claim 1 wherein the rate of delivery of said information when in the first mode of operation is initially at a first predetermined constant rate and the second state of said single mechanism changes said rate of delivery.

3. The apparatus of claim 2 wherein said second state is effectuated by actuating said mechanism in a first manner to increase said rate of delivery and actuating said mechanism in a second manner to decrease said rate of delivery.

4. The apparatus of claim 3 wherein said single mechanism is a click-and-scroll wheel.

5. The apparatus of claim 4 wherein said first manner of actuation is rolling said scroll wheel in a counter-clockwise direction and said second manner of actuation is rolling said scroll wheel in a clockwise direction.

6. The apparatus of claim 3 having an additional predetermined number of constant rates of delivery of said information each of which is unique to the others.

7. The apparatus of claim 1 wherein said information is delivered to a presentation device selected from the group consisting of: a visible presentation unit, an audio presentation unit, a textual presentation unit, and combinations thereof.

8. The apparatus of claim 1 wherein said second state controls the direction of delivery of said information when in a second of said plural modes of operation.

9. The apparatus of claim 8 wherein the rate of delivery of said information when in the second mode of operation is at a predetermined constant rate and the second state of said single mechanism changes the order of delivery of said information.

10. The apparatus of claim 9 wherein said second state is effectuated by actuating said mechanism in a first manner to deliver said information in a first order and actuating said mechanism in a second manner to deliver said information in a second order.

11. The apparatus of claim 10 further wherein said second state further includes actuating said mechanism in a third manner to pause said delivery of information.

12. The apparatus of claim 8 wherein said information is delivered to a presentation device selected from the group consisting of: a visible presentation unit, an audio presentation unit, a textual presentation unit, and combinations thereof.

13. An apparatus for controlling a device delivering information, comprising:
a device for delivering information;
software configured to present said information at a plurality of predetermined rates; and
a single mechanism having plural manners of actuation wherein a rate of delivery of said information is initially at a first of said plural rates, and wherein actuating said mechanism in a first of said plural manners increases said rate of delivery to a second of said plural rates, and wherein actuating said mechanism in a second of said plural manners decreases said rate of delivery to a third of said plural rates.

14. The apparatus of claim 13 wherein said single mechanism is a click-and-scroll wheel.

15. The apparatus of claim 14 wherein said first manner of actuation is rolling said scroll wheel in a counter-clockwise direction and said second manner of actuation is rolling said scroll wheel in a clockwise direction.

16. The apparatus of claim 13 wherein said information is delivered to a presentation device selected from the group consisting of: a visible presentation unit, an audio presentation unit, a textual presentation unit, and combinations thereof.

17. A method for controlling a device delivering information, comprising:
providing a device for delivering information wherein the device includes software configured to present the information in a plurality of modes and wherein the device includes an input mechanism having multistate operability;
switching the device between the plural modes of operation by operating the mechanism in a first state; and
controlling a rate of delivery of the information when in a first of the plural modes of operation by operating the mechanism in a second state.

18. The method of claim 17 further including the step of presenting the information on a presentation device selected from the group consisting of: a visible presentation unit, an audio presentation unit, a textual presentation unit, and combinations thereof.

19. The method of claim 17 wherein the step of operating the mechanism in the second state controls the direction of delivery of the information.

20. The method of claim 19 further including the step of presenting the information on a presentation device selected from the group consisting of: a visible presentation unit, an audio presentation unit, a textual presentation unit, and combinations thereof.
